(19) United States
(12) Patent Application Publication
(10) Pub. No.: US 2026/0050123 A1
(43) Pub. Date: Feb. 19, 2026

(54) MACH-ZEHNDER INTERFEROMETERS WITH PHASE DELAY ARMS HAVING A METAMATERIAL REGION

(71) Applicant: GlobalFoundries U.S. Inc., Malta, NY (US)

(72) Inventor: Yusheng Bian, Ballston Lake, NY (US)

(21) Appl. No.: 18/806,805

(22) Filed: Aug. 16, 2024

(51) Int. Cl. G02B 6/293; G02B 1/00; G02B 6/12; G02B 6/122; G02B 6/28

(52) U.S. Cl. CPC G02B 6/2935; G02B 1/005; G02B 6/1225; G02B 6/2861; G02B 6/12007; G02B 2006/12159; G02B 2006/12166

(57) ABSTRACT

Structures for a Mach-Zehnder interferometer and methods of forming a structure for a Mach-Zehnder interferometer. The structure comprises a first waveguide core including a first phase delay arm, and a second waveguide core including a second phase delay arm. The first phase delay arm includes a first taper, a second taper, and a plurality of segments between the first and second tapers.

### BACKGROUND

The disclosure relates to photonic chips and, more specifically, to structures for a Mach-Zehnder interferometer and methods of forming a structure for a Mach-Zehnder interferometer.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as a laser or an optical fiber.

Wavelength division multiplexing is a technology that multiplexes multiple data streams onto a single optical link. In a wavelength-division-multiplexing scheme, a set of data streams is encoded onto optical carrier signals with a different wavelength of light for each data stream. At the transmitter side of the optical link, the optical carrier signals of the individual data streams are combined (i.e., multiplexed) into a single multi-wavelength data stream by a set of wavelength-division-multiplexing filters forming a multiplexer, which has a dedicated input for the data stream of each wavelength and a single output at which the combined data streams exit for further propagation through a single optical link. At the receiver side of the optical link, a set of wavelength-division-multiplexing filters of a demultiplexer separates (i.e., demultiplexes) the optical carrier signals from the multi-wavelength data stream, and the separated optical carrier signals of the individual data streams may then be routed to corresponding photodetectors.

Conventional designs for the Mach-Zehnder interferometers used in wavelength-division-multiplexing filters may suffer from various disadvantages. For example, the waveguide cores included in conventional designs for a Mach-Zehnder interferometer may be highly sensitive to fabrication variations. Fabrication variations may result in a performance degradation, such as a significant channel drift. The performance degradation may be particularly severe in conventional designs for a Mach-Zehnder interferometer in which silicon nitride is employed to form the constituent waveguide cores.

Improved structures for a Mach-Zehnder interferometer and methods of forming a structure for a Mach-Zehnder interferometer are needed.

### SUMMARY

In an embodiment of the invention, a photonic structure comprises a waveguide core including a first taper, a second taper, and a plurality of segments between the first taper and the second taper.

In an embodiment of the invention, a structure for a Mach-Zehnder interferometer is provided. The structure comprises a first waveguide core including a first phase delay arm, and a second waveguide core including a second phase delay arm. The first phase delay arm includes a first taper, a second taper, and a plurality of segments between the first taper and the second taper.

In an embodiment of the invention, a method of forming a structure for a Mach-Zehnder interferometer is provided. The method comprises forming a first waveguide core including a first phase delay arm, and forming a second waveguide core including a second phase delay arm. The first phase delay arm includes a first taper, a second taper, and a plurality of segments between the first taper and the second taper.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a diagrammatic view of a wavelength-division-multiplexing filter in accordance with embodiments of the invention.

FIG. 2 is a top view of a structure in accordance with embodiments of the invention that may be used in a filter stage of the wavelength-division-multiplexing filter of FIG. 1.

FIG. 2A is a cross-sectional view taken generally along line 2A-2A in FIG. 2.

FIG. 2B is a cross-sectional view taken generally along line 2B-2B in FIG. 2.

FIGS. 3, 3A, 3B, and 3C are enlarged views of portions of FIG. 2.

FIGS. 4A, 4B are cross-sectional views at a fabrication stage of the processing method subsequent to FIGS. 2, 2A, 2B, 3, 3A, 3B, 3C.

FIG. 5 is a top view of a structure in accordance with alternative embodiments of the invention.

FIGS. 6, 6A are cross-sectional views of a structure in accordance with alternative embodiments of the invention.

FIGS. 7, 7A, 7B, and 7C are top views of a structure in accordance with alternative embodiments of the invention.

FIGS. 8A, 8B are cross-sectional views of a structure in accordance with alternative embodiments of the invention.

### DETAILED DESCRIPTION

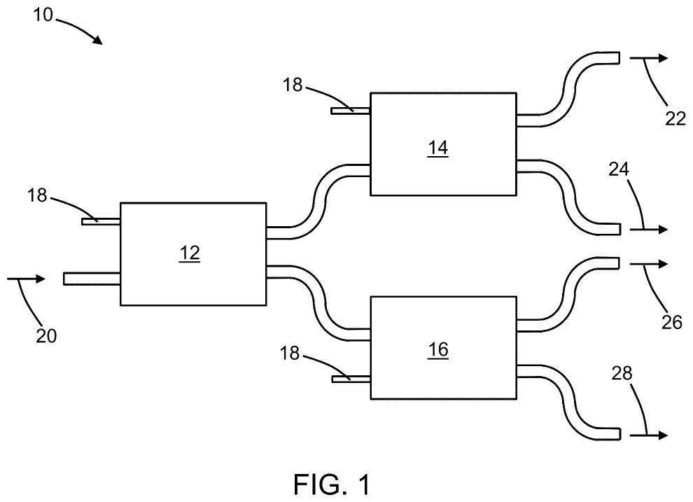

With reference to FIG. 1 and in accordance with embodiments of the invention, a wavelength-division-multiplexing filter 10 includes a filter stage 12 and a pair of filter stages 14, 16 that are coupled by waveguides to the filter stage 12. Each of the filter stages 12, 14, 16 includes an open terminal that may be coupled with a terminator 18, which may be an absorber or a grating coupler. In alternative embodiments, additional channels may be added to the wavelength-division-multiplexing filter 10 by cascading together additional filter stages with the filter stages 12, 14, 16. For example, a set of four additional filter stages may be coupled to the outputs from the filter stages 14, 16. In an embodiment, the wavelength-division-multiplexing filter 10 may enable coarse wavelength-dependent demultiplexing or multiplexing. In an embodiment, the wavelength-division-multiplexing filter 10 may enable dense wavelength-dependent demultiplexing or multiplexing. The wavelength-division-multiplexing filter 10, in any of its embodiments described herein, may be integrated into the photonic integrated circuit of a photonic chip.

The wavelength-division-multiplexing filter 10 is a multiple-channel device that may be configured to receive light 20 from a waveguide at an input to the filter stage 12 that includes mixed optical signals of multiple different wavelengths in a multi-wavelength data stream. For example, light 20 may be characterized by different wavelengths within the near infrared portion (e.g., 850 nanometers to 1650 nanometers) of the electromagnetic spectrum. In the representative embodiment, the wavelength-division-multiplexing filter 10 may be configured to receive light with four different wavelengths, namely optical signals 22, optical signals 24, optical signals 26, and optical signals 28. The filter stages 12, 14, 16 of the wavelength-division-multiplexing filter 10 may split or divide the light 20 according to wavelength. The filter stage 12 may separate the optical power for optical signals 22, 24 (e.g., odd wavelengths) from the optical power for the optical signals 26, 28 (e.g., even wavelengths). The portion of the light 20 included in the optical signals 22, 24 may be provided by a linking waveguide core from an output of the filter stage 12 to an input to the filter stage 14, and the portion of the light 20 included in the optical signals 26, 28 may be provided by a linking waveguide core from another output of the filter stage 12 to an input to the filter stage 16. The filter stage 14 separates the optical power for the optical signals 22 from the optical power for the optical signals 24, directs the portion of the light 20 included in the optical signals 22 to a waveguide core at an output, and directs the portion of the light 20 included in the optical signals 24 to a waveguide core at a different output. The filter stage 16 separates the optical power for the optical signals 26 from the optical power for the optical signals 28, directs the portion of the light 20 included in the optical signals 26 to a waveguide core at an output, and directs the portion of the light 20 included in the optical signals 28 to a waveguide core at a different output.

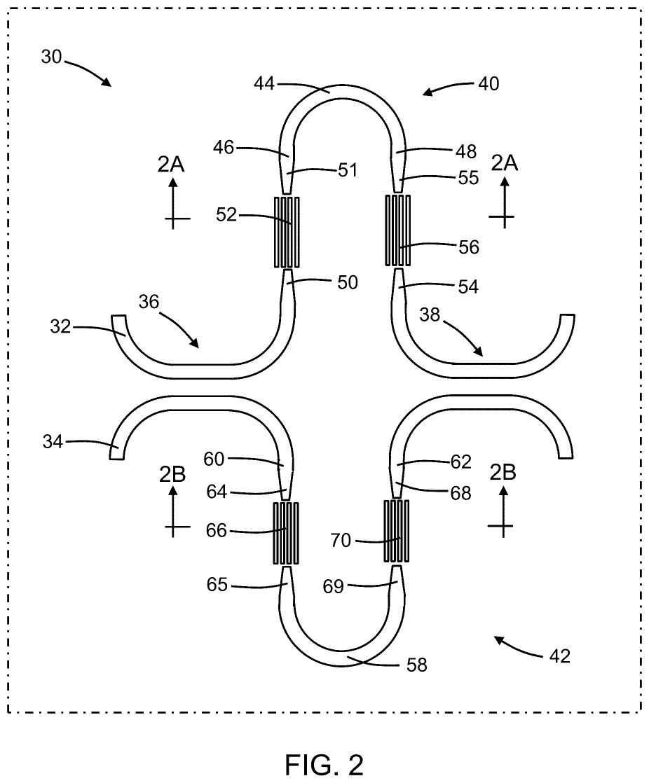

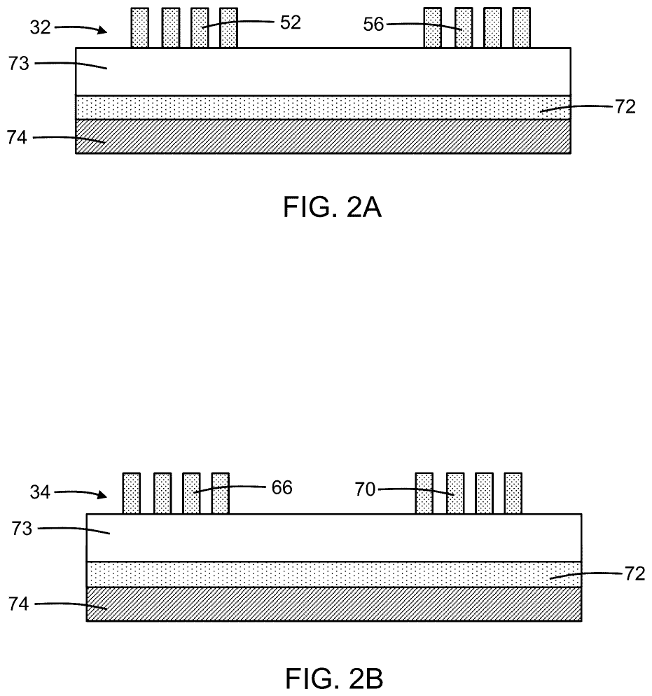

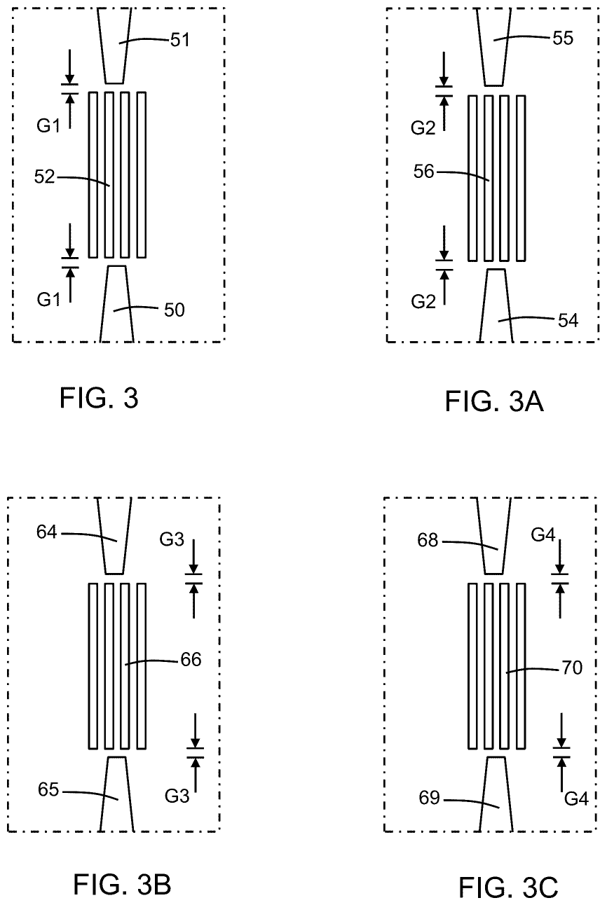

With reference to FIGS. 2, 2A, 2B, 3, 3A, 3B, 3C and in accordance with embodiments of the invention, a structure 30 for a Mach-Zehnder interferometer may be deployed as a photonic component in each of the filter stages 12, 14, 16 of the wavelength-division-multiplexing filter 10 (FIG. 1). Each of the filter stages 12, 14, 16 may include one or more cascaded instances of the structure 30.

The structure 30 includes a waveguide core 32 and a waveguide core 34 that define arms characterized by distinct optical paths of different length. The waveguide cores 32, 34 are routed to include adjacent sections that define a directional coupler 36 and adjacent sections that define a directional coupler 38. The waveguide core 32 includes a phase delay arm 40 that is joined by a bend to the section of the waveguide core 32 participating in the directional coupler 36 and that is joined by another bend to the section of the waveguide core 32 participating in the directional coupler 38. Similarly, the waveguide core 34 includes a phase delay arm 42 that is joined by a bend to the section of the waveguide core 34 participating in the directional coupler 36 and that is joined by another bend to the section of the waveguide core 34 participating in the directional coupler 38. In a representative embodiment, the bends joining the directional couplers 36, 38 to the phase delay arms 40, 42 may extend over an arc equal to about 90°. The total length and associated optical path of the phase delay arm 40 may differ from the total length and associated optical path of the phase delay arm 42. In an embodiment, the total length and associated optical path of the phase delay arm 40 may be greater than the total length and associated optical path of the phase delay arm 42. In an alternative embodiment, the directional couplers 36, 38 may be replaced by a different type of photonic coupler, such as a multi-mode interference coupler.

The phase delay arm 40 of the waveguide core 32 includes a section 44, a section 46 between the directional coupler 36 and the section 44, and a section 48 between the directional coupler 38 and the section 44. In an embodiment, the section 44 of the phase delay arm 40 may curve in a bend to connect the sections 46, 48 of the phase delay arm 40. In a representative embodiment, the section 44 may be a semicircular bend and extend over an arc equal to about 180°.

The section 46 of the phase delay arm 40 includes a taper 50, a taper 51, and multiple segments 52 that are positioned in a group between the directional coupler 36 and the section 44 of the phase delay arm 40. The segments 52 are positioned along the length of the section 46 between the taper 50 and the taper 51, the taper 50 is positioned along the length of the section 46 between the segments 52 and the directional coupler 38, and the taper 51 is positioned along the length of the section 46 between the segments 52 and the section 44. The segments 52 may have a juxtaposed, laterally-spaced arrangement with a gap laterally between each adjacent pair of segments 52. Each segment 52 may have a longitudinal axis and the segments 52 may be aligned parallel to each other along their longitudinal axes. The segments 52 are disconnected from the tapers 50, 51. Each segment 52 is truncated at opposite ends, and the opposite ends of each segment 52 have a non-contacting and spaced-apart relationship with the tapers 50, 51. In that regard, the opposite ends of each segment 52 are separated from the tapers 50, 51 by respective gaps G1. In an embodiment, the gaps G1 may be equal between the opposite ends of each segment 52 and the tapers 50, 51. In an embodiment, the width of the tapers 50, 51 may increase with increasing distance from the segments 52.

The segments 52 may be dimensioned and positioned at small enough pitch so as to define a sub-wavelength grating that does not radiate or reflect light at a wavelength of operation. For example, the periodicity of the segments 52 may be less than one-half the wavelength of the light propagating in the waveguide core 32. In an embodiment, the pitch and duty cycle of the segments 52 may be uniform. In alternative embodiments, the pitch and the duty cycle of the segments 52 may be aperiodic (i.e., non-uniform).

The section 48 of the phase delay arm 40 includes a taper 54, a taper 55, and multiple segments 56 that are positioned in a group between the directional coupler 38 and the section 44 of the phase delay arm 40. The segments 56 are positioned along the length of the section 48 between the taper 54 and the taper 55, the taper 54 is positioned along the length of the section 46 between the segments 56 and the directional coupler 38, and the taper 55 is positioned along the length of the section 46 between the segments 56 and the section 44. The segments 56 may have a juxtaposed, laterally-spaced arrangement with a gap laterally between each adjacent pair of segments 56. Each segment 56 may have a longitudinal axis and the segments 56 may be aligned parallel to each other along their longitudinal axes. Each segment 56 is truncated at opposite ends, and the opposite ends of each segment 56 have a non-contacting and spaced-apart relationship with the tapers 54, 55. In that regard, the opposite ends of each segment 56 are separated from the tapers 54, 55 by respective gaps G2. In an embodiment, the gaps G2 may be equal between the opposite ends of each segment 56 and the tapers 54, 55. In an embodiment, the width of the tapers 54, 55 may increase with increasing distance from the segments 56.

The segments 56 may be dimensioned and positioned at small enough pitch so as to define a sub-wavelength grating that does not radiate or reflect light at a wavelength of operation. For example, the periodicity of the segments 56 may be less than one-half the wavelength of the light propagating in the waveguide core 32. In an embodiment, the pitch and duty cycle of the segments 56 may be uniform. In alternative embodiments, the pitch and the duty cycle of the segments 56 may be aperiodic (i.e., non-uniform).

The phase delay arm 42 includes a section 58, a section 60 between the directional coupler 36 and the section 58, and a section 62 between the directional coupler 38 and the section 58. In an embodiment, the section 58 of the phase delay arm 42 may curve in a bend to connect the sections 60, 62 of the phase delay arm 42. In a representative embodiment, the section 58 may be a semicircular bend and extend over an arc equal to about 180°.

The section 60 of the phase delay arm 42 includes a taper 64, a taper 65, and multiple segments 66 that are positioned in a group between the directional coupler 36 and the section 44 of the phase delay arm 42. The segments 66 are positioned along the length of the section 48 between the taper 64 and the taper 65, the taper 64 is positioned along the length of the section 48 between the segments 66 and the directional coupler 36, and the taper 65 is positioned along the length of the section 48 between the segments 66 and the section 58. The segments 66 may have a juxtaposed, laterally-spaced arrangement with a gap laterally between each adjacent pair of segments 66. Each segment 66 may have a longitudinal axis and the segments 66 may be aligned parallel to each other along their longitudinal axes. Each segment 66 is truncated at opposite ends, and the opposite ends of each segment 66 have a non-contacting and spaced-apart relationship with the tapers 64, 65. In that regard, the opposite ends of each segment 66 are separated from the tapers 64, 65 by respective gaps G3. In an embodiment, the gaps G3 may be equal between the opposite ends of each segment 66 and the tapers 64, 65. In an embodiment, the width of the tapers 64, 65 may increase with increasing distance from the segments 66.

The segments 66 may be dimensioned and positioned at small enough pitch so as to define a sub-wavelength grating that does not radiate or reflect light at a wavelength of operation. For example, the periodicity of the segments 66 may be less than one-half the wavelength of the light propagating in the waveguide core 34. In an embodiment, the pitch and duty cycle of the segments 66 may be uniform. In alternative embodiments, the pitch and the duty cycle of the segments 66 may be aperiodic (i.e., non-uniform).

The section 62 of the phase delay arm 40 includes a taper 68, a taper 69, and multiple segments 70 that are positioned in a group between the directional coupler 36 and the section 44 of the phase delay arm 42. The segments 70 are positioned along the length of the section 48 between the taper 68 and the taper 69, the taper 68 is positioned along the length of the section 48 between the segments 66 and the directional coupler 38, and the taper 69 is positioned along the length of the section 48 between the segments 70 and the section 58. The segments 70 may have a juxtaposed, laterally-spaced arrangement with a gap laterally between each adjacent pair of segments 70. Each segment 70 may have a longitudinal axis and the segments 70 may be aligned parallel to each other along their longitudinal axes. Each segment 70 is truncated at opposite ends, and the opposite ends of each segment 70 have a non-contacting and spaced-apart relationship with the tapers 68, 69. In that regard, the opposite ends of each segment 70 are separated from the tapers 68, 69 by respective gaps G4. In an embodiment, the gaps G4 may be equal between the opposite ends of each segment 70 and the tapers 68, 69. In an embodiment, the width of the tapers 68, 69 may increase with increasing distance from the segments 70.

The segments 70 may be dimensioned and positioned at small enough pitch so as to define a sub-wavelength grating that does not radiate or reflect light at a wavelength of operation. For example, the periodicity of the segments 70 may be less than one-half the wavelength of the light propagating in the waveguide core 34. In an embodiment, the pitch and duty cycle of the segments 70 may be uniform. In alternative embodiments, the pitch and the duty cycle of the segments 70 may be aperiodic (i.e., non-uniform).

The waveguide cores 32, 34 may be positioned in a vertical direction over a dielectric layer 72, a dielectric layer 73, and a semiconductor substrate 74. In an embodiment, the dielectric layers 72, 73 may be comprised of a dielectric material, such as silicon dioxide, and the semiconductor substrate 74 may be comprised of a semiconductor material, such as single-crystal silicon. In an embodiment, the dielectric layer 72 may be a buried oxide layer of a silicon-on-insulator substrate, and the dielectric layers 72, 73 may separate the waveguide cores 32, 34 from the semiconductor substrate 74. In an alternative embodiment, the dielectric layer 73 may be omitted such that only the dielectric layer 72 separates the waveguide cores 32, 34 from the semiconductor substrate 74.

In an embodiment, the waveguide cores 32, 34 may be comprised of a material having a refractive index that is greater than the refractive index of silicon dioxide. In an embodiment, the waveguide cores 32, 34 may be comprised of a dielectric material, such as silicon nitride. In an alternative embodiment, the waveguide cores 32, 34 may be comprised of a different dielectric material, such as silicon oxynitride or aluminum nitride. In an alternative embodiment, the waveguide cores 32, 34 may be comprised of a semiconductor material, such as single-crystal silicon, amorphous silicon, or polycrystalline silicon. In alternative embodiments, other materials, such as a polymer or a III-V compound semiconductor, may be used to form the waveguide cores 32, 34.

In an embodiment, the waveguide cores 32, 34 may be formed by patterning a layer of material with lithography and etching processes. In an embodiment, the waveguide cores 32, 34 may be formed by patterning a deposited layer of a material (e.g., silicon nitride). In an alternative embodiment, the waveguide cores 32, 34 may be formed by patterning the semiconductor material (e.g., single-crystal silicon) of a device layer of a silicon-on-insulator substrate. In an embodiment, the segments 52, the segments 56, the segments 66, and the segments 70 may have lower portions that are connected by a slab layer of lesser thickness than the waveguide cores 32, 34.

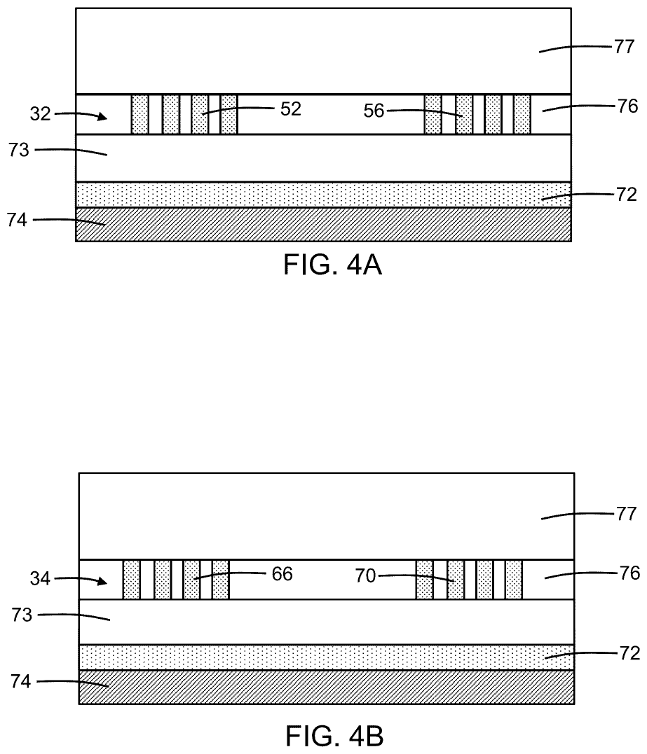

With reference to FIGS. 4A, 4B and at a fabrication stage subsequent to FIGS. 2, 2A, 2B, 3, 3A, 3B, 3C, a dielectric layer 76 is formed over the waveguide cores 32, 34. The dielectric layer 76 may be comprised of a dielectric material, such as silicon dioxide, that is deposited and then planarized following deposition. The dielectric material constituting the dielectric layer 76 may have a refractive index that is less than the refractive index of the material constituting the waveguide cores 32, 34. A back-end-of-line stack 77 may be formed over the dielectric layer 76. The back-end-of-line stack 77 may include stacked dielectric layers in which each dielectric layer is comprised of a dielectric material, such as silicon dioxide, silicon nitride, tetraethylorthosilicate silicon dioxide, or fluorinated-tetraethylorthosilicate silicon dioxide.

The dielectric material of the dielectric layer 76 may be positioned in the spaces between the segments 52, the segments 56, the segments 66, and the segments 70 such that metamaterial structures may be defined as regions of the phase delay arms 40, 42 in which the material constituting the segments 52, the segments 56, the segments 66, and the segments 70 has a higher refractive index than the dielectric material of the dielectric layer 76. Each metamaterial structure can be treated as a homogeneous material having an effective refractive index that is intermediate between the refractive index of the material constituting the segments 52, the segments 56, the segments 66, and the segments 70 and the refractive index of the dielectric material constituting the dielectric layer 76.

In use, light is input into the directional coupler 36 via either the waveguide core 32 or the waveguide core 34, and the directional coupler 36 splits the light between the waveguide core 32 and the waveguide core 34. A portion of the split light propagates in the phase delay arm 40 of the waveguide core 32 and another portion of the split light propagates the phase delay arm 42 of the waveguide core 34. The difference in the lengths of the optical path in phase delay arm 40 and the optical path in phase delay arm 42 provides phase modulation, which results in intensity modulation at the output from the directional coupler 38.

The length of the phase delay arm 40, the length of the phase delay arm 42, the splitting ratio of the directional coupler 36, and the splitting ratio of the directional coupler 38 can be varied to vary the performance of the structure 30 or, alternatively, to target the Mach-Zehnder interferometer embodied in the structure 30 for deployment in a specific application, such as use in one of the filter stages 12, 14, 16 of the wavelength-division-multiplexing filter 10 (FIG. 1). Due to the introduction of the segments 52, the segments 56, the segments 66, and the segments 70, the structure 30 may be characterized by an improved tolerance to fabrication variations. In that regard, the segments 52, the segments 56, the segments 66, and the segments 70 may function to push the mode of the light outside of the waveguide cores 32, 34 such that the sensitivity to fabrication variations is reduced. The structure 30 embodied in the Mach-Zehnder interferometer may be effective to reduce channel drift.

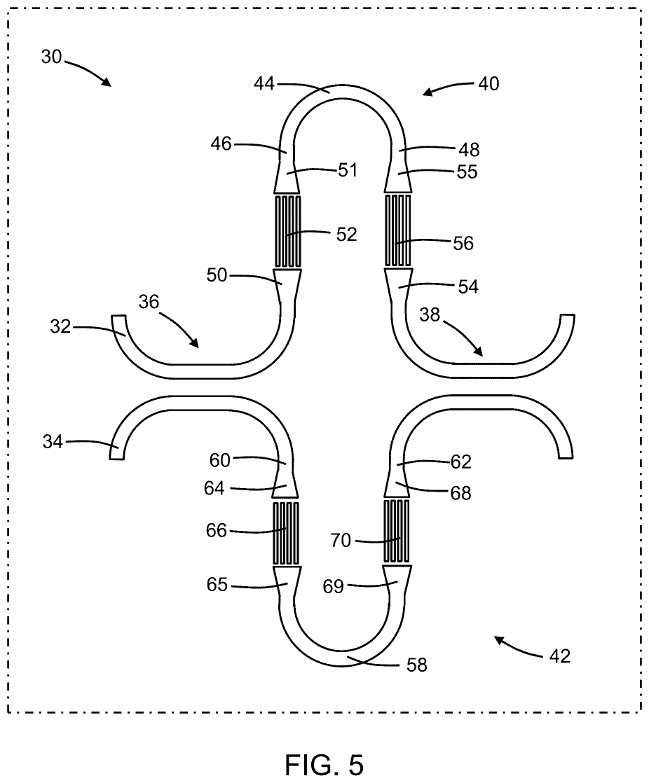

With reference to FIG. 5 and in accordance with alternative embodiments of the invention, the directionality of the tapers 50, 51, the directionality of the tapers 54, 55, the directionality of the tapers 64, 65, and/or the directionality of the tapers 68, 69 may be inverted. Specifically, the widths of the tapers 50, 51 may decrease with increasing distance from the segments 52, the widths of the tapers 54, 55 may decrease with increasing distance from the segments 56, the widths of the tapers 64, 65 may decrease with increasing distance from the segments 66, and/or the widths of the tapers 68, 69 may decrease with increasing distance from the segments 70.

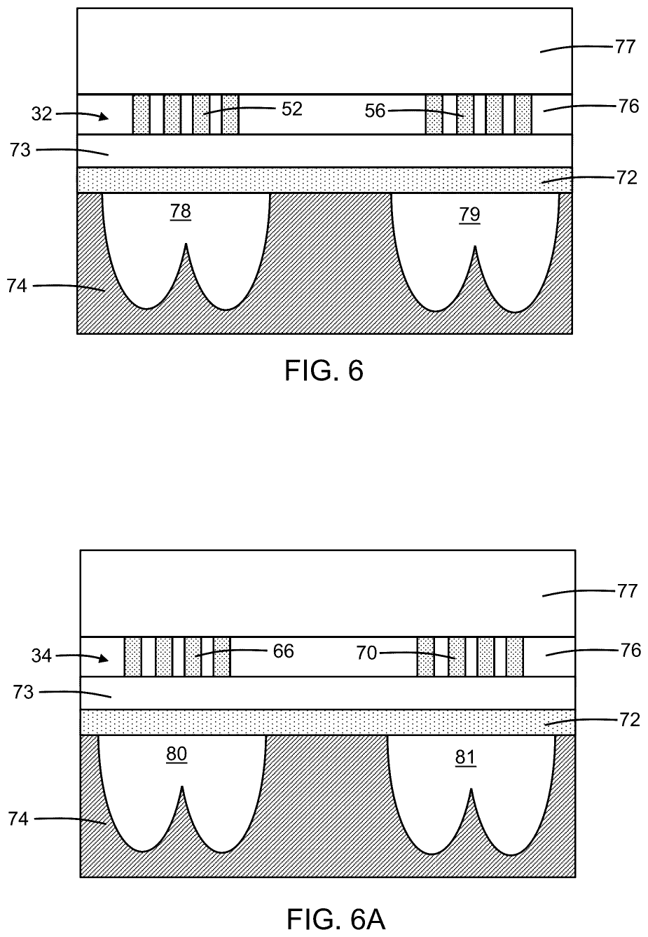

With reference to FIGS. 6, 6A and in accordance with alternative embodiments, the structure 30 may be modified to add cavities 78, 79 and cavities 80, 81 in the semiconductor substrate 74. The tapers 50, 51 and segments 52 may overlap with the cavity 78, the tapers 54, 55 and segments 56 may overlap with the cavity 79, the tapers 64, 65 and segments 66 may overlap with the cavity 80, and the tapers 68, 69 and segments 70 may overlap with the cavity 81. The cavities 78, 79 and the cavities 80, 81 may be formed by an isotropic etching process that includes a vertical etching component and a lateral etching component. The cavities 78, 79 and the cavities 80, 81 may be filled by air or a different material. In an embodiment, the cavities 78, 79 and the cavities 80, 81 may include a pair of interconnected chambers.

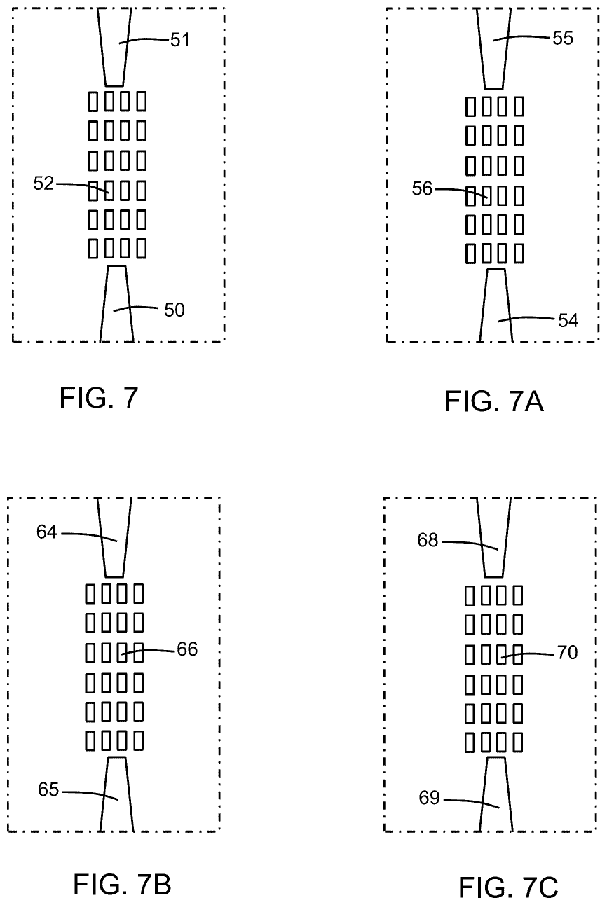

With reference to FIGS. 7, 7A, 7B, 7C and in accordance with alternative embodiments, the segments 52 may be partitioned into rows of shorter length, the segments 56 may be partitioned into rows of shorter length, the segments 66 may be partitioned into rows of shorter length, and the segments 70 may be partitioned into rows of shorter length. The shorter segments 52 in the different rows may be arranged in columns to define a two-dimensional array, the shorter segments 56 in the different rows may also be arranged in columns to define a two-dimensional array, the shorter segments 66 in the different rows may be arranged in columns to define a two-dimensional array, and the shorter segments 70 in the different rows may also be arranged in columns to define a two-dimensional array.

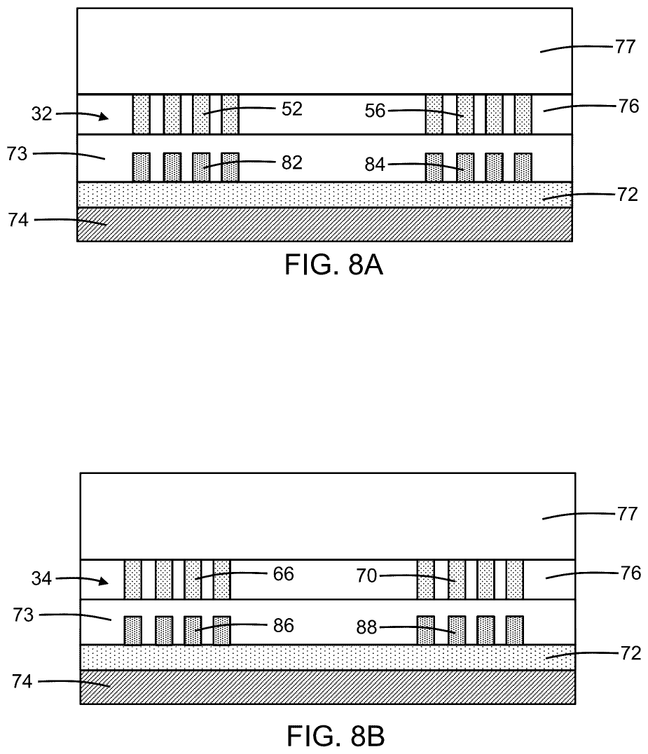

With reference to FIGS. 8A, 8B and in accordance with alternative embodiments, the structure 30 may be modified to add multiple segments 82 positioned between the segments 52 and the semiconductor substrate 74, multiple segments 84 positioned between the segments 56 and the semiconductor substrate 74, multiple segments 86 positioned between the segments 66 and the semiconductor substrate 74, and multiple segments 88 positioned between the segments 70 and the semiconductor substrate 74. In an embodiment, the segments 82, 84, 86, 88 may be comprised of the same material. In an embodiment, the segments 82, 84, 86, 88 may be comprised of a different material than the segments 52, 56, 66, 70. In an embodiment, the segments 82, 84, 86, 88 may be comprised of silicon, and the segments 52, 56, 66, 70 may be comprised of silicon nitride.

The segments 82 may have a juxtaposed, laterally-spaced arrangement with a gap laterally between each adjacent pair of segments 82. Each segment 82 may have a longitudinal axis and the segments 82 may be aligned parallel to each other along their longitudinal axes. In an embodiment, the segments 52 may overlap with the segments 82. In an embodiment, the segments 52 may fully overlap with the segments 82.

The segments 84 may have a juxtaposed, laterally-spaced arrangement with a gap laterally between each adjacent pair of segments 84. Each segment 84 may have a longitudinal axis and the segments 84 may be aligned parallel to each other along their longitudinal axes. In an embodiment, the segments 56 may overlap with the segments 84. In an embodiment, the segments 56 may fully overlap with the segments 84.

The segments 86 may have a juxtaposed, laterally-spaced arrangement with a gap laterally between each adjacent pair of segments 86. Each segment 86 may have a longitudinal axis and the segments 86 may be aligned parallel to each other along their longitudinal axes. In an embodiment, the segments 66 may overlap with the segments 86. In an embodiment, the segments 66 may fully overlap with the segments 86.

The segments 88 may have a juxtaposed, laterally-spaced arrangement with a gap laterally between each adjacent pair of segments 88. Each segment 88 may have a longitudinal axis and the segments 88 may be aligned parallel to each other along their longitudinal axes. In an embodiment, the segments 70 may overlap with the segments 88. In an embodiment, the segments 70 may fully overlap with the segments 88.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A photonic structure comprising:
a waveguide core including a first taper, a second taper, and a first plurality of segments between the first taper and the second taper.

2. The photonic structure of claim 1 wherein the first taper has a first width that increases with increasing distance from the first plurality of segments, and the second taper has a second width that increases with increasing distance from the first plurality of segments.

3. The photonic structure of claim 1 wherein the first taper has a first width that decreases with increasing distance from the first plurality of segments, and the second taper has a second width that decreases with increasing distance from the first plurality of segments.

4. The photonic structure of claim 1 wherein the first plurality of segments have a parallel alignment lengthwise between the first taper and the second taper.

5. The photonic structure of claim 1 wherein the first plurality of segments are separated from the first taper by a first gap, and the first plurality of segments are separated from the second taper by a second gap.

6. The photonic structure of claim 1 further comprising:
a second plurality of segments between the first taper and the second taper; and
a dielectric layer comprised of a dielectric material,
wherein the dielectric material of the dielectric layer is positioned between the first plurality of segments and the second plurality of segments, and the first plurality of segments overlap with the second plurality of segments.

7. The photonic structure of claim 1 wherein the first plurality of segments comprise a metamaterial.

8. A structure for a Mach-Zehnder interferometer, the structure comprising:
a first waveguide core including a first phase delay arm, the first phase delay arm including a first taper, a second taper, and a first plurality of segments between the first taper and the second taper; and
a second waveguide core including a second phase delay arm.

9. The structure of claim 8 further comprising:
a first directional coupler; and
a second directional coupler,
wherein the first phase delay arm of the first waveguide core and the second phase delay arm of the second waveguide core are positioned between the first directional coupler and the second directional coupler.

10. The structure of claim 9 wherein the first phase delay arm has a first total length between the first directional coupler and the second directional coupler, the second phase delay arm has a second total length between the first directional coupler and the second directional coupler, and the first total length differs from the first total length.

11. The structure of claim 8 wherein the first phase delay arm and the second phase delay arm comprise silicon nitride.

12. The structure of claim 8 wherein the first phase delay arm includes a third taper, a fourth taper, and a second plurality of segments between the third taper and the fourth taper.

13. The structure of claim 8 wherein the second phase delay arm includes a third taper, a fourth taper, and a second plurality of segments between the third taper and the fourth taper, the first plurality of segments have a parallel alignment lengthwise between the first taper and the second taper, and the second plurality of segments have a parallel alignment lengthwise between the third taper and the fourth taper.

14. The structure of claim 8 wherein the first taper has a first width that increases with increasing distance from the first plurality of segments, and the second taper has a second width that increases with increasing distance from the first plurality of segments.

15. The structure of claim 8 wherein the first taper has a first width that decreases with increasing distance from the first plurality of segments, and the second taper has a second width that decreases with increasing distance from the first plurality of segments.

16. The structure of claim 8 wherein the first plurality of segments have a parallel alignment lengthwise between the first taper and the second taper.

17. The structure of claim 8 wherein the first plurality of segments are separated from the first taper by a first gap, and the first plurality of segments are separated from the second taper by a second gap.

18. The structure of claim 8 further comprising:
a second plurality of segments between the first taper and the second taper; and
a dielectric layer comprised of a dielectric material,
wherein the dielectric material of the dielectric layer is positioned between the first plurality of segments and the second plurality of segments, and the first plurality of segments overlap with the second plurality of segments.

19. The structure of claim 8 wherein the first plurality of segments comprise a metamaterial.

20. A method of forming a structure for a Mach-Zehnder interferometer, the method comprising:
forming a first waveguide core including a first phase delay arm, wherein the first phase delay arm includes a first taper, a second taper, and a plurality of segments between the first taper and the second taper; and
forming a second waveguide core including a second phase delay arm.
